(19) United States
(12) Patent Application Publication
(10) Pub. No.: US 2012/0126123 A1
(43) Pub. Date: May 24, 2012

(54) Method of Measuring Characteristics of Specimen, Measuring Device, and Filter Device

(75) Inventors: Takashi Kondo, Kyoto-Fu (JP); Kazuhiro Takigawa, Kyoto-Fu (JP); Seiji Kamba, Kyoto-Fu (JP)

(73) Assignee: Murata Manufacturing Co., Ltd.

(21) Appl. No.: 13/359,609

(22) Filed: Jan. 27, 2012

Related U.S. Application Data
(63) Continuation of application No. PCT/JP2010/060038, filed on Jun. 14, 2010.

(30) Foreign Application Priority Data
Jul. 29, 2009 (JP) 2009-176382

(51) Int. Cl. G01J 5/00; G02B 5/20

(52) U.S. Cl. 250/341.1; 250/338.1; 359/350

(57) ABSTRACT

A method of measuring specimen characteristics that includes holding a specimen on a gap array structure that includes gaps regularly arrayed in at least one array direction, applying a linearly-polarized electromagnetic wave to the gap array structure on which the specimen is held, detecting the electromagnetic wave scattered by the gap array structure, and measuring characteristics of the specimen based on a frequency characteristic of the detected scattered electromagnetic wave, wherein a polarizing direction of the linearly-polarized electromagnetic wave and a principal surface of the gap array structure are not parallel to each other.

### CROSS REFERENCE TO RELATED APPLICATIONS

The present application is a continuation of International application No. PCT/JP2010/060038, filed Jun. 14, 2010, which claims priority to Japanese Patent Application No. 2009-176382, filed Jul. 29, 2009, the entire contents of each of which are incorporated herein by reference.

### FIELD OF THE INVENTION

The present invention relates to a method of placing a specimen on a gap array structure, applying an electromagnetic wave to the gap array structure on which the specimen is placed, and analyzing a scattered spectrum of the electromagnetic wave, thereby measuring characteristics of the specimen, and to a measuring device utilizing that method. Also, the present invention relates to a filter device allowing passage of the electromagnetic wave therethrough.

### BACKGROUND OF THE INVENTION

Hitherto, characteristics of substances have been analyzed by a method of placing a specimen on a gap array structure, applying an electromagnetic wave to the gap array structure on which the specimen is placed, and analyzing a transmittance spectrum of the electromagnetic wave, thereby measuring characteristics of the specimen. More specifically, there is, for example, a method of applying a terahertz wave to a metal mesh including, e.g., a protein attached as a specimen thereto, and analyzing a transmittance spectrum of the terahertz wave.

As such a related-art transmittance spectrum analyzing method using the electromagnetic wave, Japanese Unexamined Patent Application Publication No. 2008-185552 (Patent Literature (PTL) 1) discloses a method of measuring characteristics of a specimen by employing a gap array structure (e.g., a metal mesh) having a gap region, a specimen held a plane surface of the gap array structure, an electromagnetic wave applying portion for applying an electromagnetic wave toward the specimen, and an electromagnetic wave detecting portion for measuring the electromagnetic wave that has transmitted through the gap array structure, the method including the steps of applying the electromagnetic wave toward the gap array structure from the electromagnetic wave applying portion such that the electromagnetic wave obliquely enters the plane surface including the gap region, and detecting the characteristics of the specimen based on the fact that a position of a dip waveform generated in a frequency characteristic of a measured value is shifted with the presence of the specimen (see FIGS. 3 and 9 of Japanese Unexamined Patent Application Publication No. 2008-185552).

With the above-described measuring method, in order to obtain the dip waveform, the electromagnetic wave needs to be obliquely entered to the plane surface of the gap array structure, the plane surface including the gap region. As a condition for the oblique incidence, Japanese Unexamined Patent Application Publication No. 2008-185552 states that an angle (incidence angle α) formed by a linear line perpendicularly intersecting the plane surface of the gap array structure, in which gaps are arrayed, with respect to an optical axis of an optical system is up to 10° and preferably about several degrees (see FIG. 4 and paragraphs [0023]-[0025] of Japanese Unexamined Patent Application Publication No. 2008-185552). In practice, however, the dip waveform is not generated or it does not clearly appear in some cases depending on the positional relationship between a direction in which the gap array structure is inclined (i.e., a direction of an axis of rotation when the gap array structure is inclined) and a polarizing direction of the electromagnetic wave. It is also required to set optimum conditions for further sharpening the dip waveform from the viewpoint of improving sensitivity in measurement of a minute amount of specimen.
PTL 1: Japanese Unexamined Patent Application Publication No. 2008-185552

### SUMMARY OF THE INVENTION

In view of the above-described state of the art, an object of the present invention is to provide a method of measuring characteristics of a specimen with improved sensitivity in measurement and higher reproducibility, and a measuring device for use in that method.

The present invention provides a method comprising the steps of holding a specimen on a gap array structure that includes gaps regularly arrayed in at least one array direction, applying a linearly-polarized electromagnetic wave to the gap array structure on which the specimen is held, detecting the electromagnetic wave scattered by the gap array structure, and measuring characteristics of the specimen based on a frequency characteristic of the detected electromagnetic wave, wherein a polarizing direction of the electromagnetic wave and a principal surface of the gap array structure are not parallel to each other.

In the above-described method, preferably, the gap array structure is arranged in a posture rotated about a particular rotation axis by a certain angle from a state where the principal surface of the gap array structure is perpendicular to a propagating direction of the electromagnetic wave and where one of the array directions of the gaps and the polarizing direction of the electromagnetic wave are aligned with each other.

In the above-described method, preferably, an angle formed between a projected line, which is obtained by projecting the rotation axis to the principal surface of the gap array structure, and the polarizing direction of the electromagnetic wave is not 0°.

In the above-described method, preferably, the rotation axis is parallel to the principal surface of the gap array structure.

Preferably, the certain angle by which the gap array structure is rotated about the rotation axis is not 0°.

In the above-described method, preferably, the gap array structure includes the gaps arrayed in a quadrate array.

Further, the present invention provides a device (2) comprising a gap array structure for holding a specimen, the gap array structure including gaps that are regularly arrayed in at least one array direction, an irradiation unit for applying a linearly-polarized electromagnetic wave to the gap array structure on which the specimen is held, and a detection unit for detecting the electromagnetic wave scattered by the gap array structure, the device measuring characteristics of the specimen based on a frequency characteristic of the detected electromagnetic wave, wherein a polarizing direction of the electromagnetic wave and a principal surface of the gap array structure are not parallel to each other.

In the above-described device, preferably, the gap array structure is arranged in a posture rotated about a particular rotation axis by a certain angle from a state where the principal surface of the gap array structure is perpendicular to a propagating direction of the electromagnetic wave and where one of the array directions of the gaps and the polarizing direction of the electromagnetic wave are aligned with each other.

In the above-described device, preferably, an angle formed between a projected line, which is obtained by projecting the rotation axis to the principal surface of the gap array structure, and the polarizing direction of the electromagnetic wave is not 0°.

In the above-described device, preferably, the rotation axis is parallel to the principal surface of the gap array structure.

Preferably, the certain angle by which the gap array structure is rotated about the rotation axis is not 0°.

In the above-described device, preferably, the gap array structure includes the gaps arrayed in a quadrate array.

Still further, the present invention provides a filter device for cutting off a linearly-polarized electromagnetic wave of a particular frequency, the filter device comprising a gap array structure including gaps that are regularly arrayed in at least one array direction, wherein the filter device is arranged such that a polarizing direction of the electromagnetic wave and a principal surface of the gap array structure are not parallel to each other.

In the above-described filter device, preferably, the gap array structure is arranged in a posture rotated about a particular rotation axis by a certain angle from a state where the principal surface of the gap array structure is perpendicular to a propagating direction of the electromagnetic wave and where one of the array directions of the gaps and the polarizing direction of the electromagnetic wave are aligned with each other.

In the above-described filter device, preferably, an angle formed between a projected line, which is obtained by projecting the rotation axis to the principal surface of the gap array structure, and the polarizing direction of the electromagnetic wave is not 0°.

In the above-described filter device, preferably, the rotation axis is parallel to the principal surface of the gap array structure.

Preferably, the certain angle by which the gap array structure is rotated about the rotation axis is not 0°.

In the above-described filter device, preferably, the gap array structure includes the gaps arrayed in a quadrate array.

According to the present invention, by setting the inclination of the gap array structure to a certain direction with respect to the polarizing direction of the electromagnetic wave, it is possible to reliably generate a dip waveform in a transmittance spectrum, for example, and to measure the characteristics of the specimen with high sensitivity. Further, since variations in measurement are suppressed, the measurement can be performed with high reproducibility.

### BRIEF DESCRIPTION OF THE DRAWINGS

FIG. 1 is a schematic view to explain a measuring method and a measuring device according to the present invention.

FIG. 2(a) is a perspective view illustrating one example of a gap array structure used in the present invention. FIG. 2(b) is a schematic view to explain a lattice structure of the gap array structure.

FIG. 3 is a schematic sectional view to explain one example of an installed state of the gap array structure in the present invention.

FIG. 4(a) is a graph plotting a transmittance spectrum obtained in EXAMPLE 1. FIG. 4(b) is a partial enlarged graph of FIG. 4(a).

FIG. 5 is a graph to explain variables of the transmittance spectrum, which are defined in the present invention.

FIGS. 6(a) to 6(c) represent graphs plotting the relationship of an angle (ψ) formed between a projected line, which is obtained by projecting a rotation axis of the gap array structure to a principal surface of the gap array structure, and a polarizing direction of an electromagnetic wave with respect to the variables of the transmittance spectrum on condition that the rotation angle (θ) is 9°. Specifically, FIG. 6(a) is a graph plotting the relationship of the angle (ψ) versus a variable D, FIG. 6(b) is a graph plotting the relationship of the angle (ψ) versus a variable FWHM, and FIG. 6(c) is a graph plotting the relationship of the angle (ψ) versus a variable fx.

FIGS. 7(a) to 7(c) represent graphs plotting the relationship of the angle (ψ) formed between the projected line, which is obtained by projecting the rotation axis of the gap array structure to the principal surface of the gap array structure, and the polarizing direction of the electromagnetic wave with respect to the variables of the transmittance spectrum on condition that the rotation angle (θ) is 5°. Specifically, FIG. 7(a) is a graph plotting the relationship of the angle (ψ) versus the variable D, FIG. 7(b) is a graph plotting the relationship of the angle (ψ) versus the variable FWHM, and FIG. 7(c) is a graph plotting the relationship of the angle (ψ) versus the variable fx.

FIGS. 8(a) to 8(c) represent graphs plotting the relationship of the angle (ψ) formed between the projected line, which is obtained by projecting the rotation axis of the gap array structure to the principal surface of the gap array structure, and the polarizing direction of the electromagnetic wave with respect to the variables of the transmittance spectrum on condition that the rotation angle (θ) is 12°. Specifically, FIG. 8(a) is a graph plotting the relationship of the angle (ψ) versus the variable D, FIG. 8(b) is a graph plotting the relationship of the angle (ψ) versus the variable FWHM, and FIG. 8(c) is a graph plotting the relationship of the angle (ψ) versus the variable fx.

FIGS. 9(a) to 9(c) represent graphs plotting transmittance spectra in EXAMPLE 2. Specifically, FIG. 9(a) plots the transmittance spectrum on condition of ψ=0° and θ=0°, FIG. 9(b) plots the transmittance spectrum on condition of ψ=0° and θ=9°, and FIG. 9(c) plots the transmittance spectrum on condition of ψ=90° and θ=9°.

### DETAILED DESCRIPTION OF THE INVENTION

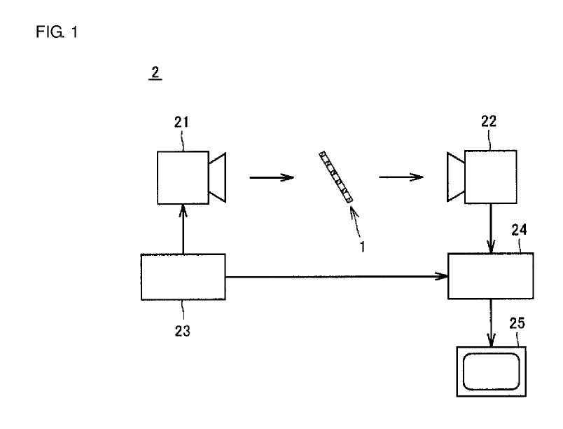

One example of a measuring method according to the present invention will be described below with reference to FIG. 1. FIG. 1 is a schematic view illustrating an overall configuration of a measuring device 2 according to the present invention and the layout of a gap array structure 1 in the measuring device 2. As illustrated in FIG. 1, the measuring device 2 includes an irradiation unit 21 for generating and emitting an electromagnetic wave, and a detection unit 22 for detecting the electromagnetic wave that has been scattered by the gap array structure 1. Further, the measuring device 2 includes an irradiation control unit 23 for controlling the operation of the irradiation unit 21, an analysis processing unit 24 for analyzing the result detected by the detection unit 22, and a display unit 25 for displaying the result analyzed by the analysis processing unit 24. The irradiation control unit 23 may be connected to the analysis processing unit 24 for the purpose of synchronizing the timing of the detection. The term “scattering” used in the present invention implies a wide-sense concept including transmission as one form of forward scattering, reflection as one form of backward scattering, etc. Preferably, the term “scattering” implies transmission and reflection. More preferably, the term “scattering” implies transmission in the 0-th order direction and reflection in the 0-th order direction.

In general, given that a lattice interval of a grating (i.e., a gap interval in this description) is d, an incidence angle is i, a diffraction angle is θ, and a wavelength is λ, a spectrum diffracted by the grating can be expressed by:

d(sin i−sin θ)=nλ (1)

The “0-th order” in the term “0-th order direction” implies the case where n in the above formula (1) is 0. Because d and λ cannot take 0, n=0 holds only when sin i−sin θ=0 is satisfied. Thus, the “0-th order direction” implies the direction in which the incidence angle and the diffraction angle are equal to each other, i.e., in which a propagating direction of the electromagnetic wave is not changed.

In the above-described measuring device 2, the irradiation unit 21 generates and emits the electromagnetic wave under control of the irradiation control unit 23. The electromagnetic wave emitted from the irradiation unit 21 is applied to the gap array structure 1, and the electromagnetic wave scattered by the gap array structure 1 is detected by the detection unit 22. The electromagnetic wave detected by the detection unit 22 is transferred as an electric signal to the analysis processing unit 24 and is displayed on the display unit 25 in the visually recognizable form, such as a frequency characteristic of transmittance (transmittance spectrum).

The electromagnetic wave used in the measuring method and the measuring device according to the present invention is not limited to particular one, but it is preferably a terahertz wave having frequency of 20 GHz to 120 THz, for example. One practical example of the electromagnetic wave is a terahertz wave that is generated with the optical rectification effect of an electro-optical crystal, e.g., ZnTe, by using a short optical pulse laser as a light source. Another example is a terahertz wave that is obtained by using a short optical pulse laser as a light source, exciting free electrons in a photoconductive antenna, and applying a voltage to the photoconductive antenna to accelerate the free electrons such that a current flows momentarily.

In the present invention, the expression “measuring the characteristics of the specimen” implies quantitative, qualitative, and other measurements of a compound as the specimen. There are, for example, the case of measuring a minute content of the specimen in, e.g., a solution and the case of identifying the specimen. One practical method includes the steps of immersing the gap array structure in a solution in which the specimen is dissolved, washing a solvent and the extra specimen after the specimen has been attached to the surface of the gap array structure, drying the gap array structure, and measuring characteristics of the specimen by using the above-described measuring device.

The gap array structure used in the present invention is a structure including gaps that are arrayed in at least one array direction, and it is a structure scattering an electromagnetic wave when the structure is irradiated with the electromagnetic wave. Preferably, the gap array structure is a quasi-periodic structure or a periodic structure. The term “quasi-periodic structure” implies a structure in which translational symmetry is not held, but the array is orderly kept. Examples of the quasi-periodic structure include a Fibonacci structure as a one-dimensional quasi-periodic structure, and a Penrose structure as a two-dimensional quasi-periodic structure. The term “periodic structure” implies a structure having spatial symmetry such as represented by translational symmetry. The periodic structure is classified into one-dimensional periodic structure, a two-dimensional periodic structure, and a three-dimensional periodic structure. The one-dimensional periodic structure is, for example, a wire grid structure or a one-dimensional grating. The two-dimensional periodic structure is, for example, a mesh filter or a two-dimensional grating. Among those periodic structures, the two-dimensional periodic structure is preferably employed. More preferably, a two-dimensional periodic structure including gaps regularly arrayed in both vertical and horizontal directions (i.e., in a quadrate array) is employed.

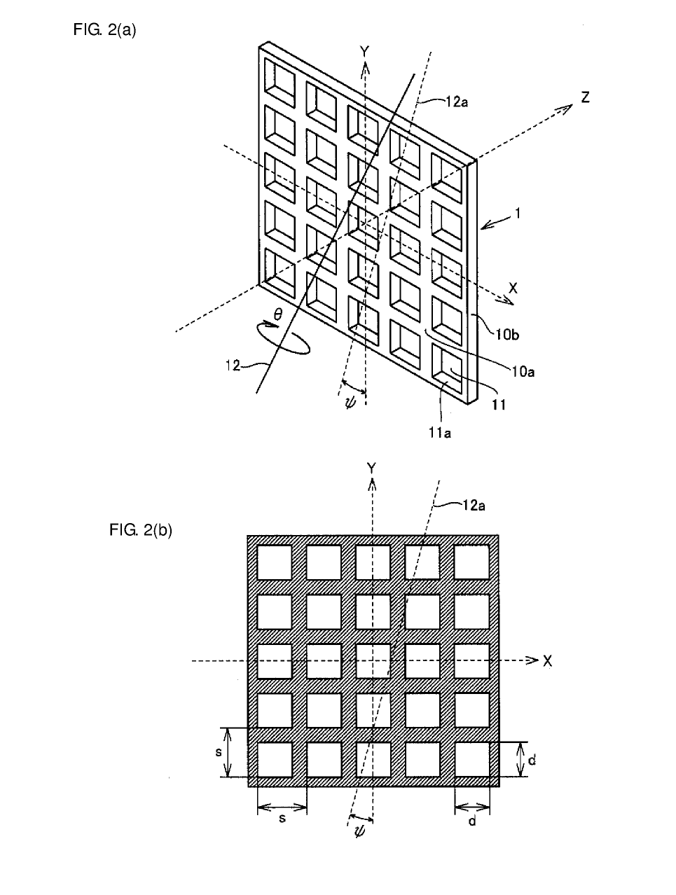

One example of the two-dimensional periodic structure including the gaps in the quadrate array is a plate-like structure (lattice structure) in which the gaps are arrayed in a matrix pattern at constant intervals, as illustrated in FIGS. 2(a) and 2(b). The gap array structure 1, illustrated in FIG. 2(a), is a plate-like structure in which gaps 11, each having a square shape as viewed from the front side of a principal surface 10a, are formed at equal intervals in two array directions (vertical and horizontal directions in FIG. 2) that are parallel to two sides of the square shape of the gap. The shape of the gap is not limited to the square, and it may be, e.g., rectangular, circular, or elliptic. Further, the intervals in the two array directions may be not equal to each other insofar as the gaps are in the quadrate array. For example, the gaps are in a rectangular array.

The shape and the size of the gaps of the gap array structure are designed, as appropriate, depending on the measuring method, the material characteristics of the gap array structure, the frequency of the electromagnetic wave used, etc. It is hence difficult to generalize respective ranges of parameters of the gaps. However, when the electromagnetic wave scattered forward is detected, it is preferable in the gap array structure 1 illustrated in FIG. 2(a) that the lattice interval of the gaps, denoted by s in FIG. 2(b), is not shorter than 1/10 and not longer than 10 times the wavelength of the electromagnetic wave used in the measurement. If the lattice interval s of the gaps is outside that range, the electromagnetic wave may be less apt to scatter in some cases. Further, it is preferable that the opening size of the gap, denoted by d in FIG. 2(b), is not smaller than 1/10 and not larger than 10 times the wavelength of the electromagnetic wave used in the measurement. If the opening size d of the gaps is outside that range, the intensity of the electromagnetic wave scattered forward may be so reduced as to cause a difficulty in detecting the signal in some cases.

Further, the thickness of the gap array structure is designed, as appropriate, depending on the measuring method, the material characteristics of the gap array structure, the frequency of the electromagnetic wave used, etc. It is hence difficult to generalize the range of thickness of the gap array structure. However, when the electromagnetic wave scattered forward is detected, the thickness of the gap array structure is preferably not larger than several times the wavelength of the electromagnetic wave used in the measurement. If the structure thickness is outside that range, the intensity of the electromagnetic wave scattered forward may be so reduced as to cause a difficulty in detecting the signal in some cases.

The gap array structure is preferably arranged in a posture rotated by a certain angle about a particular rotation axis from a state where that the principal surface of the gap array structure is perpendicular to the propagating direction of the electromagnetic wave and where one of the array directions of the gaps and a polarizing direction of the electromagnetic wave are aligned with each other. Further, preferably, an angle formed between a projected line, which is obtained by projecting the rotation axis to the principal surface of the gap array structure, and the polarizing direction of the electromagnetic wave is not 0°. In addition, preferably, the rotation axis is parallel to the principal surface of the gap array structure. Those features of the present invention will be described below with reference to FIG. 2.

In the gap array structure 1 illustrated by an example in FIG. 2(a), the gaps 11 are arrayed at constant intervals in both the vertical and horizontal directions (i.e., in the square array). In FIG. 2(a), the horizontal array direction of the gaps 11 is defined as an X-axis, and the vertical array direction of the gaps 11 is defined as a Y-axis. Also, the direction perpendicular to an X-Y plane is defined as a Z-axis. The propagating direction of the electromagnetic wave applied to the gap array structure 1 is the Z-axis direction denoted in FIG. 2(a), and the polarizing direction of the electromagnetic wave is the Y-axis direction denoted in FIG. 2(a).

FIG. 2(a) illustrates a state where the principal surface 10a of the gap array structure 1 is perpendicular to the propagating direction (Z-axis) of the electromagnetic wave, and where one of the array directions of the gaps 11, i.e., the Y-axis direction, and the polarizing direction of the electromagnetic wave are aligned with each other. In the present invention, the gap array structure 1 is arranged in a posture rotated about a particular rotation axis 12 by a certain angle θ from the above-mentioned state. Further, preferably, an angle ψ formed between a projected line 12a, which is obtained by projecting the rotation axis 12 to the principal surface 10a of the gap array structure 1, and the polarizing direction of the electromagnetic wave (i.e., the Y-axis direction) is not 0°. The rotation axis 12 may be positioned away from the gap array structure 1. While FIG. 2(a) illustrates the case where the rotation axis 12 is twisted with respect to the principal surface 10a of the gap array structure 1, the rotation axis 12 is preferably parallel to the principal surface 10a of the gap array structure 1.

Given θ=9°, sharpness of a dip appearing in a frequency characteristic, such as a transmittance spectrum, depends on the angle ψ, and there is a value of the angle ψ at which the sharpness of the dip waveform is maximized. When the gap array structure 1 is constituted by the quadrate array of the gaps 11, the dip waveform appears in the transmittance spectrum with the angle ψ being other than 0° (namely, no dip appears at ψ=0). As the angle ψ approaches 90°, the dip waveform becomes sharper and the sharpness is maximized at the angle ψ of 90°. Thus, the angle ψ formed between the rotation axis 12 and the polarizing direction (Y-axis direction) of the electromagnetic wave is preferably 1° to 90°, more preferably 30° to 90°, even more preferably 60° to 90°, and most preferably 85° to 90°.

Also, given θ=5°, sharpness of the dip appearing in the frequency characteristic, such as the transmittance spectrum, depends on the angle ψ, and there is a value of the angle ψ at which the sharpness of the dip waveform is maximized. When the gap array structure 1 is constituted by the quadrate array of the gaps 11, the dip waveform appears in the transmittance spectrum with the angle ψ being other than 0° (namely, no dip appears at ψ=0). As the angle ψ approaches 90°, the dip waveform becomes sharper and the sharpness is maximized at the angle ψ of 90°.

Also, given θ=12°, sharpness of the dip appearing in the frequency characteristic, such as the transmittance spectrum, depends on the angle ψ, and there is a value of the angle ψ at which the sharpness of the dip waveform is maximized. When the gap array structure 1 is constituted by the quadrate array of the gaps 11, the dip waveform appears in the transmittance spectrum with the angle ψ being other than 0° (namely, no dip appears at ψ=0). As the angle ψ approaches 90°, the dip waveform becomes sharper and the sharpness is maximized at the angle ψ of 90°.

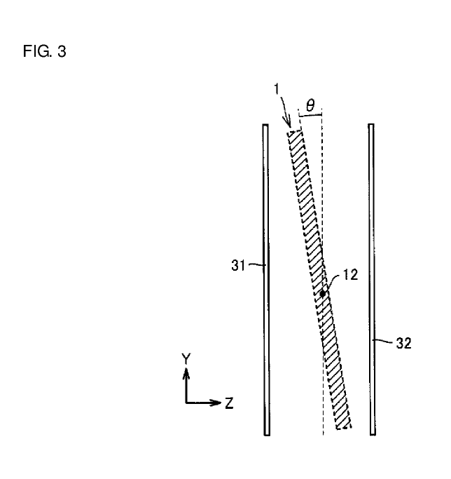

FIG. 3 is a schematic sectional view illustrating one example of an installed state of the gap array structure when the angle ψ formed between the projected line 12a of the rotation axis 12 and the polarizing direction of the electromagnetic wave (i.e., the Y-axis direction) is 90°. FIG. 3 illustrates the case where the gap array structure is rotated by the angle θ with the rotation axis 12 set to the X-axis direction that is perpendicular to the drawing sheet.

In the present invention, the specimen can be held on the gap array structure by optionally using one of various known methods. For example, the specimen may be directly attached to the gap array structure or may be attached to it with, e.g., a support film interposed therebetween. However, the specimen is preferably directly attached to the surface of the gap array structure from the viewpoint of improving measurement sensitivity and reducing variations in the measurement, thereby performing the measurement with higher reproducibility.

Direct attachment of the specimen to the gap array structure includes not only the case where chemical bonding, for example, is directly formed between the surface of the gap array structure and the specimen, but also the case where, by using the gap array structure to which a host molecule is bonded in advance, the specimen is bonded to the host molecule. Examples of the chemical bonding include covalent bonding (e.g., covalent bonding between a metal and a thiol group), Van der Waals bonding, ionic bonding, metal bonding, and hydrogen bonding. Of those examples, the covalent bonding is preferable. The term “host molecule” implies a molecule capable of being bonded specifically to the specimen. Combinations of the host molecule and the specimen are, for example, an antigen and an antibody, a sugar chain and a protein, a lipid and a protein, a low-molecule compound (ligand) and a protein, a protein and a protein, a single strand DNA and a single strand DNA.

When the specimen is directly attached to the gap array structure, it is preferable to use the gap array structure in which at least a part of its surface is formed by a conductor. The expression “at least a part of the surface of the gap array structure 1” implies, for example, a part of any of the principal surface 10a, a side surface 10b, and a side surface 11a of the gap, which are illustrated in FIG. 2(a).

Herein, the term “conductor” implies an object (substance) capable of conducting electricity therethrough, and it includes not only a metal, but also a semiconductor. Examples of the metal include a metal capable of bonding to a functional group, such as a hydroxyl group, a thiol group, or a carboxyl group, of a compound containing that functional group, a metal capable of coating a functional group, such as a hydroxyl group or an amino group, on a surface of the metal, and an alloy of those metals. More specifically, the metals are gold, silver, copper, iron, nickel, chromium, silicon, germanium, etc. Of those examples, gold, silver, copper, nickel, and chromium are preferable. Gold is more preferable. Using gold or nickel is advantageous in that, particularly when the specimen contains a thiol group (—SH group), the thiol group can be bonded to the surface of the gap array structure. Further, using nickel is advantageous in that, particularly when the specimen contains a hydroxyl group (—OH) or a carboxyl group (—COOH), such a functional group can be bonded to the surface of the gap array structure. Examples of the semiconductor include compound semiconductors and organic semiconductors. The compound semiconductors are, for example, a group IV semiconductor (e.g., Si or Ge), a group II-VI semiconductor (e.g., ZnSe, Cds or ZnO), a group III-V semiconductor (e.g., GaAs, InP or GaN), a group IV compound semiconductor (e.g., SiC or SiGe), and a group I-III-VI semiconductor (e.g., CuInSe₂).

Attaching the specimen to the gap array structure with, e.g., a support film interposed therebetween can be performed, for example, by a method of sticking a support film made of, e.g., a polyamide resin to the surface of the gap array structure and attaching the specimen to the support film, or a method of using a gas-tight or liquid-tight container instead of the support film and measuring a fluid or a substance dispersed in a fluid.

Further, the gap array structure in which the gaps are regularly arrayed in at least one array direction can also be used as a component of a filter device for cutting off a linearly-polarized electromagnetic wave of a particular frequency. Such a filter device is used, for example, with intent to remove an electromagnetic wave of a particular frequency from the linearly-polarized electromagnetic wave that is applied to the specimen from some electromagnetic wave generator.

In the above-described filter device, the gap array structure is preferably arranged in a posture rotated by a certain angle about a particular rotation axis from a state where the principal surface of the gap array structure is perpendicular to the propagating direction of the electromagnetic wave, and where one of the array directions of the gaps and the polarizing direction of the electromagnetic wave are aligned with each other. Further, preferably, the angle formed between the projected line, which is obtained by projecting the rotation axis to the principal surface of the gap array structure, and the polarizing direction of the electromagnetic wave is not 0°. By so arranging the gap array structure, a filter device can be obtained which does not transmit (i.e., can cut off) only the linearly-polarized electromagnetic wave of a particular frequency (e.g., a frequency corresponding to the dip waveform of the transmittance spectrum obtained with the above-described measuring method and measuring device) in a certain frequency range.

### EXAMPLES

The present invention will be described in more detail below in connection with EXAMPLES, but the present invention is not limited to the following EXAMPLES.

### Example 1

Transmittances were calculated through simulation by using the electromagnetic simulator MicroStripes (registered trademark) made by CST AG. with the following gap array structure used as a model.

The gap array structure used as a model in this EXAMPLE 1 is a plate-like structure, which is entirely made of copper and which has square holes arrayed in a square lattice pattern as illustrated in the schematic view of FIG. 2(a). The lattice interval of the gap array structure (denoted by s in FIG. 2(b)) is 260 μm, the hole size (denoted by d in FIG. 2(b)) is 180 μm, and the thickness is 60 μm. The entirety of the gap array structure has a plate-like shape of 1.3 mm square.

Further, the gap array structure 1 of this EXAMPLE 1 is arranged such that its principal surface 10a is positioned perpendicularly to the propagating direction of the electromagnetic wave (i.e., the Z-axis direction), and that one of the array directions of the gaps 11 is aligned with the polarizing direction of the electromagnetic wave.

The simulation is carried out on a model in which, as illustrated in FIG. 3, the gap array structure 1 is installed between two ports 31 and 32 arranged with a spacing of 460 μm left therebetween. A distance between the port 31 and the center of gravity of the gap array structure 1 is 230 μm. Also, a distance between the port 32 and the center of gravity of the gap array structure 1 is 230 μm. The port 31 represents a light source for generating an electromagnetic wave. The port 31, 32 represents a measuring member, which is in the form of a plate having a principal surface of 1.3 mm square and having a thickness of 60 μm, and which measures the amount of light having transmitted through the gap array structure 1.

The rotation axis 12 is defined as a linear line passing the center of gravity of the gap array structure 1 and being parallel to the principal surface 10a of the gap array structure 1. The angle (denoted by ψ in FIG. 2(a)) formed between the projected line 12a, which is obtained by projecting the rotation axis 12 to the principal surface 10a of the gap array structure 1, and the polarizing direction of the electromagnetic wave (i.e., the Y-axis direction) is changed from 0° to 90°, and the angle (denoted by θ in FIG. 2(a)) by which the gap array structure 1 is rotated about the rotation axis 12 is set to 9°. The polarizing direction of the incident electromagnetic wave is set to the Y-axis direction defined in FIG. 2(a), and the polarizing direction of the incident electromagnetic wave detected at each port is also set to the Y-axis direction.

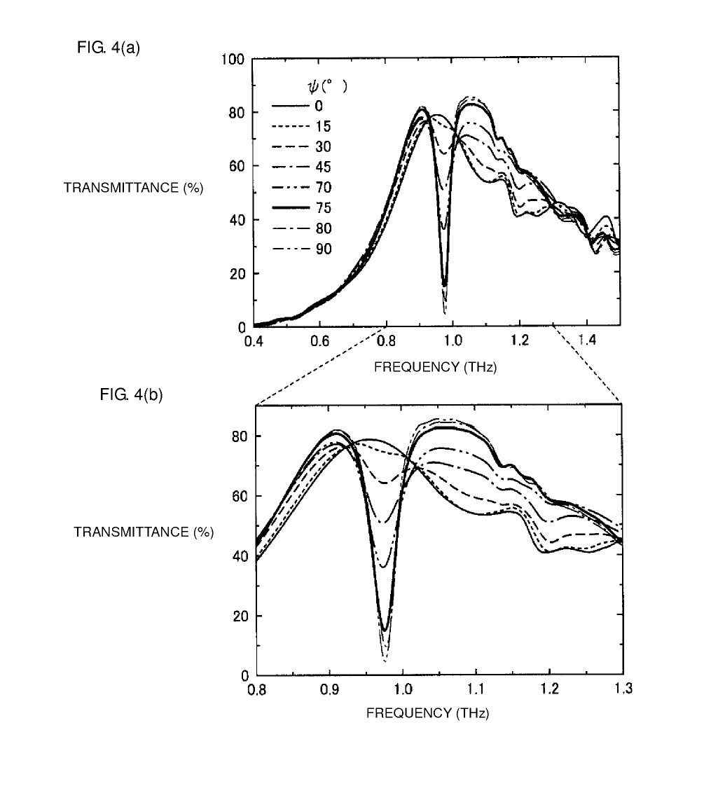

FIG. 4(a) represents a part of the transmittance spectrum obtained with the calculation. FIG. 4(b) represents a spectrum illustrating the transmittance spectrum in a frequency range of 0.8 to 1.3 THz in FIG. 4(a) in a horizontally enlarged scale.

As seen from the shapes of the transmittance spectra plotted in FIGS. 4(a) and 4(b), when the angle ψ formed between the projected line 12a of the rotation axis 12 and the polarizing direction of the electromagnetic wave is small, a clear dip waveform does not appear on the transmittance spectrum. Also, as the angle ψ increases, the dip waveform becomes sharper and the sharpness is maximized at the angle ψ of 90°. The term “dip waveform” implies a local inverse peak that usually appears in, e.g., the transmittance spectrum in a frequency region (i.e., a band-pass region) where the transmittance of an electromagnetic wave is high. In FIG. 4, an inverse peak appearing near 0.95 Hz in the band-pass region of about 0.8 to 1.3 THz indicates the dip waveform.

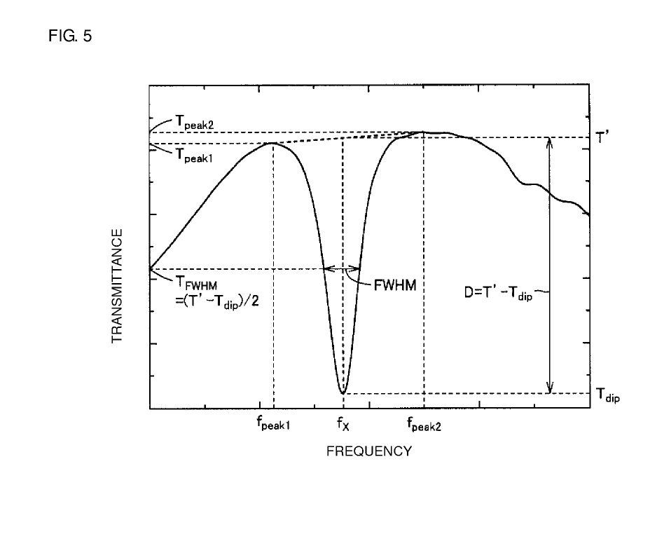

For the purpose of quantitatively analyzing the results of FIG. 4, several variables regarding shape characteristics of the transmittance spectrum are defined as illustrated in FIG. 5. First, the transmittance (local maximum value) at a peak frequency fₚₑₐₖ₁ on the lower frequency side than a dip is denoted by Tₚₑₐₖ₁ the transmittance (local maximum value) at a peak frequency fₚₑₐₖ₂ on the higher frequency side than the dip is denoted by Tₚₑₐₖ₂, and the transmittance (local minimum value) at a dip frequency fₓ is denoted by T_{dip}. An intersection between a line connecting Tₚₑₐₖ₁ and Tₚₑₐₖ₂ and a line representing fₓ is denoted by T′, and an intermediate value {(T′+T_{dip})/2} between T′ and T_{dip} is denoted by T_{FWHM}. The difference [T′−T_{dip}] between T′ and T_{dip} is denoted by a depth (D) of the dip waveform. Further, the width of the dip at T_{FWHM} in the transmittance spectrum is denoted by a full width at half maximum (FWHM) of the dip.

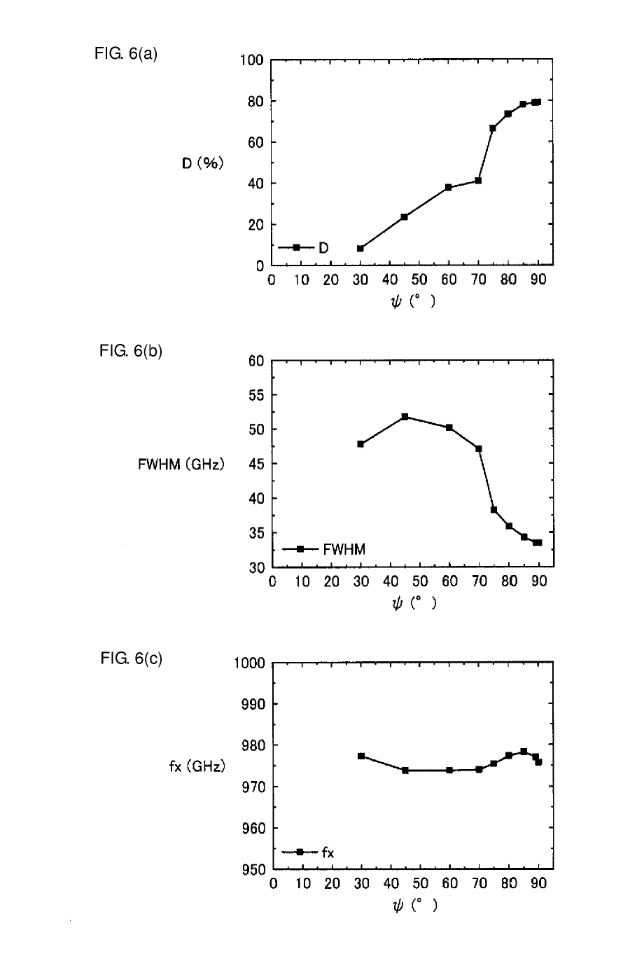

For the transmittance spectra illustrated in FIG. 4, FIG. 6(a) plots the relationship between D and the angle ψ (30 to 90°), FIG. 6(b) plots the relationship between FWHM and the angle ψ, and FIG. 6(c) plots the relationship between fₓ and the angle ψ. As seen from FIG. 6(a), as the angle ψ increases, the depth (D) of the dip waveform increases. As seen from FIG. 6(b), as the angle ψ increases, the full width at half maximum (FWHM) of the dip decreases as a whole. An inflection point appears near the angle ψ=70° in FIGS. 6(a) and 6(b), but the reason is unknown. Further, as seen from FIG. 6(c), regardless of change of the angle ψ, fₓ denoting the position of the inverse peak of the dip remains within a certain range and a change rate of fₓ is small.

In this EXAMPLE 1, as described above, the gap array structure 1 is arranged in such a state that its principal surface 10a is perpendicular to the propagating direction of the electromagnetic wave (i.e., the Z-axis direction), and that one of the array directions of the gaps 11, i.e., the Y-axis direction, is aligned with the polarizing direction of the electromagnetic wave. However, the array direction of the gaps 11 and the polarizing direction of the electromagnetic wave may form an angle at a certain value therebetween insofar as such an angle does not significantly affect the sharpness of the dip waveform.

### Example 2

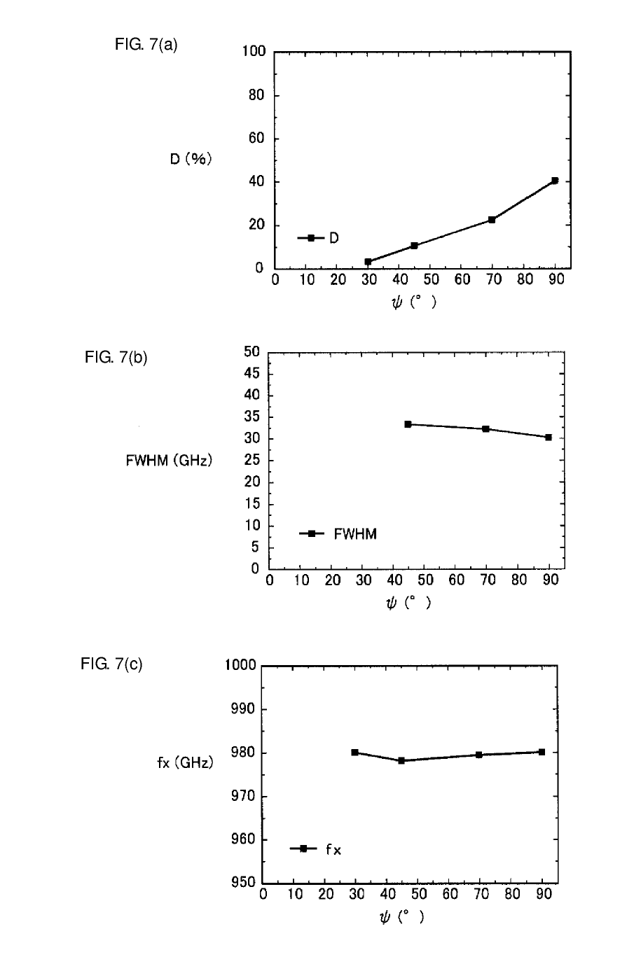

Transmittances were calculated through simulation under the same conditions as those in EXAMPLE 1 except for setting the angle θ to 5° and changing the angle ψ from 30° to 90°. For transmittance spectra obtained with the calculation, FIG. 7(a) plots the relationship between D, defined above, and the angle ψ, FIG. 7(b) plots the relationship between FWHM and the angle ψ, and FIG. 7(c) plots the relationship between fₓ and the angle ψ. As seen from FIG. 7(a), as the angle ψ increases, the depth (D) of the dip waveform increases. As seen from FIG. 7(b), as the angle ψ increases, the full width at half maximum (FWHM) of the dip decreases as a whole. Further, as seen from FIG. 7(c), regardless of change of the angle ψ, fₓ denoting the position of the inverse peak of the dip remains within a certain range and a change rate of fₓ is small.

### Example 3

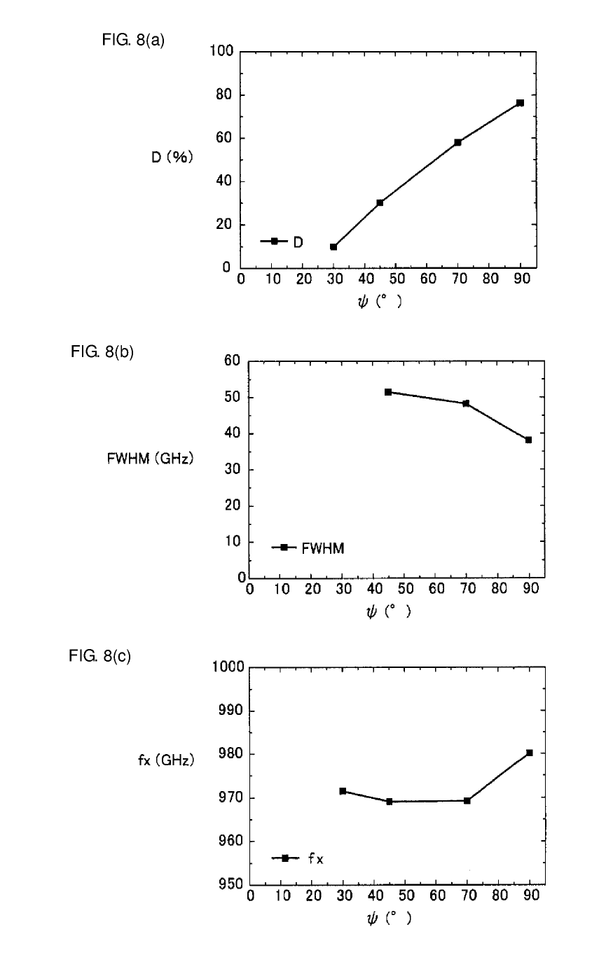

Transmittances were calculated through simulation under the same conditions as those in EXAMPLE 1 except for setting the angle θ to 12° and changing the angle ψ from 30° to 90°. For transmittance spectra obtained with the calculation, FIG. 8(a) plots the relationship between D, defined above, and the angle ψ, FIG. 8(b) plots the relationship between FWHM and the angle ψ, and FIG. 8(c) plots the relationship between fₓ and the angle ψ. As seen from FIG. 8(a), as the angle ψ increases, the depth (D) of the dip waveform increases. As seen from FIG. 8(b), as the angle ψ increases, the full width at half maximum (FWHM) of the dip decreases as a whole. Further, as seen from FIG. 8(c), regardless of change of the angle ψ, fₓ denoting the position of the inverse peak of the dip remains within a certain range and a change rate of fₓ is small.

From the above-mentioned results, it is understood that as the angle ψ increases, the dip waveform becomes sharper. Thus, the quantitative analysis also shows that the sharpness of the dip waveform is maximized at the angle ψ=90°, i.e., when the gap array structure 1 is rotated about the X-axis as illustrated in FIG. 3.

### Comparative Example

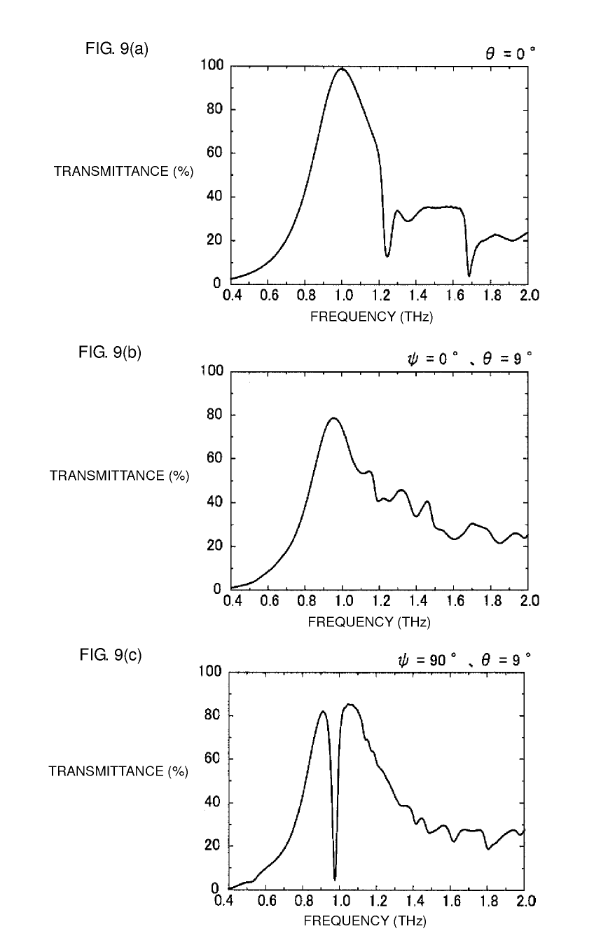

As COMPARATIVE EXAMPLE, transmittances were calculated through simulation under the same conditions as those in EXAMPLE 1 except for setting the angle θ to 0° and setting the angle ψ to 0°. FIGS. 9(a) to 9(c) plot transmittance spectra obtained with the calculation. More specifically, FIG. 9(a) plots the transmittance spectrum when the principal surface of the gap array structure is positioned perpendicularly to the propagating direction of the electromagnetic wave (i.e., corresponding to the case of the angle θ=0°). In the transmittance spectrum of FIG. 9(a), there does not appear such a dip waveform as illustrated in FIG. 9(c) described below. FIG. 9(b) plots the transmittance spectrum when the gap array structure is rotated from the state of FIG. 2(a) by 9° about the rotation axis, which passes the center of gravity of the gap array structure 1 and which extends in a direction (Y-axis direction in FIG. 2) parallel to the polarizing direction of the electromagnetic wave (i.e., corresponding to the case of ψ=0° and θ=9°). In the transmittance spectrum of FIG. 9(b), there also does not appear such a dip waveform as illustrated in FIG. 9(c) described below.

In contrast, FIG. 9(c) plots the transmittance spectrum when the gap array structure is rotated from the state of FIG. 2(a) by 9° about the rotation axis, which passes the center of gravity of the gap array structure 1 and which extends in a direction (X-axis direction in FIG. 2) perpendicular to the polarization plane of the electromagnetic wave (i.e., corresponding to the case of ψ=90° in EXAMPLE 1). As seen from the transmittance spectrum of FIG. 9(c), a sharp dip waveform appears near the frequency of 1 THz. In FIG. 9, an inverse peak appearing near about 1.0 THz is the dip waveform.

The above-described advantageous effect of the present invention is presumably attributable to the fact that, when the principal surface of the metal mesh is arranged in a state inclined to the wave front of the applied electromagnetic wave, the electromagnetic wave in a particular frequency band is diffracted. Further, the frequency of the diffracted electromagnetic wave is determined depending on the dielectric constant near the surface of the metal mesh. Accordingly, it is deemed that the advantageous effect of sharpening the shape of the dip waveform and increasing sensitivity in measurement of the characteristics of the specimen is obtained depending on the arrangement adapted for generating the diffracted wave, specifically the arrangement adapted for generating the diffracted wave with higher efficiency.

It is to be noted that the foregoing embodiments and EXAMPLES are disclosed here for only illustrative purposes in all respects and they should not be construed in a limiting sense. The scope of the present invention is defined in the attached claims without being bound to the foregoing description, and it is intended to encompass all implications equivalent to the claims and all modifications within the scope.

### REFERENCE SIGNS LIST

1 gap array structure
10a principal surface
10b side surface
11 gap
11a side surface of gap
12 rotation axis
12a projected line
2 measuring device
21 irradiation unit
22 detection unit
23 irradiation control unit
24 analysis processing unit
25 display unit
31, 32 ports

1. A method of measuring specimen characteristics, the method comprising:
applying a linearly-polarized electromagnetic wave to a specimen on a gap array structure, the gap array structure including gaps regularly arrayed in at least one array direction;
detecting an electromagnetic wave scattered by the gap array structure; and
measuring characteristics of the specimen based on a frequency characteristic of the detected scattered electromagnetic wave,
wherein a polarizing direction of the linearly-polarized electromagnetic wave and a principal surface of the gap array structure are not parallel to each other.

2. The method according to claim 1, wherein the gap array structure is arranged in a posture rotated about a rotation axis by a rotation angle from a state where the principal surface of the gap array structure is perpendicular to a propagating direction of the linearly-polarized electromagnetic wave and where one of the array directions of the gaps and the polarizing direction of the linearly-polarized electromagnetic wave are aligned with each other.

3. The method according to claim 2, wherein a projection angle formed between a projected line, which is obtained by projecting the rotation axis to the principal surface of the gap array structure, and the polarizing direction of the electromagnetic wave is not 0°.

4. The method according to claim 2, wherein the rotation axis is parallel to the principal surface of the gap array structure.

5. The method according to claim 2, wherein the rotation angle by which the gap array structure is rotated about the rotation axis is not 0°.

6. The method according to claim 1, wherein the gap array structure includes the gaps arrayed in a quadrate array.

7. A device for measuring specimen characteristics, the device comprising:
a gap array structure configured to hold a specimen, the gap array structure including gaps that are regularly arrayed in at least one array direction;
an irradiation unit that applies a linearly-polarized electromagnetic wave to the gap array structure on which the specimen is held; and
a detection unit that detects the electromagnetic wave scattered by the gap array structure, and measures characteristics of the specimen based on a frequency characteristic of the detected scattered electromagnetic wave,
wherein a polarizing direction of the linearly-polarized electromagnetic wave and a principal surface of the gap array structure are not parallel to each other.

8. The device according to claim 7, wherein the gap array structure is arranged in a posture rotated about a rotation axis by a rotation angle from a state where the principal surface of the gap array structure is perpendicular to a propagating direction of the linearly-polarized electromagnetic wave and where one of the array directions of the gaps and the polarizing direction of the linearly-polarized electromagnetic wave are aligned with each other.

9. The device according to claim 8, wherein a projection angle formed between a projected line, which is obtained by projecting the rotation axis to the principal surface of the gap array structure, and the polarizing direction of the electromagnetic wave is not 0°.

10. The device according to claim 8, wherein the rotation axis is parallel to the principal surface of the gap array structure.

11. The device according to claim 8, wherein the rotation angle by which the gap array structure is rotated about the rotation axis is not 0°.

12. The device according to claim 7, wherein the gap array structure includes the gaps arrayed in a quadrate array.

13. A filter device for cutting off a linearly-polarized electromagnetic wave of a particular frequency, the filter device comprising:
a gap array structure including gaps that are regularly arrayed in at least one array direction,
wherein the filter device is arranged such that a polarizing direction of the linearly-polarized electromagnetic wave and a principal surface of the gap array structure are not parallel to each other.

14. The filter device according to claim 13, wherein the gap array structure is arranged in a posture rotated about a rotation axis by a rotation angle from a state where the principal surface of the gap array structure is perpendicular to a propagating direction of the linearly-polarized electromagnetic wave and where one of the array directions of the gaps and the polarizing direction of the linearly-polarized electromagnetic wave are aligned with each other.

15. The filter device according to claim 14, wherein a projection angle formed between a projected line, which is obtained by projecting the rotation axis to the principal surface of the gap array structure, and the polarizing direction of the linearly-polarized electromagnetic wave is not 0°.

16. The filter device according to claim 14, wherein the rotation axis is parallel to the principal surface of the gap array structure.

17. The filter device according to claim 14, wherein the rotation angle by which the gap array structure is rotated about the rotation axis is not 0°.

18. The filter device according to claim 13, wherein the gap array structure includes the gaps arrayed in a quadrate array.
